(19) United States
(12) Patent Application Publication
(10) Pub. No.: US 2002/0014031 A1
(43) Pub. Date: Feb. 7, 2002

(54) Fishing lure

(76) Inventor: Stephen M. Brinkman, Beeville, TX (US)

Correspondence Address: LAW OFFICES OF CHRISTOPHER L. MAKAY, 1634 Milam Building, 115 East Travis Street, San Antonio, TX, 78205, US

(21) Appl. No.: 09/901,470

(22) Filed: Jul. 9, 2001

Related U.S. Application Data
(63) Continuation-in-part of application No. 09/535,880, filed on Mar. 28, 2000.

(51) Int. Cl. A01K 85/00

(52) U.S. Cl. 43/42.31

(57) ABSTRACT

A fishing lure includes a body, a cartridge suitable for insertion into the body, and a removable head securable to the body. The removable head is configured to either facilitate diving or maintain a desired level as the fishing lure is pulled through surrounding water. The cartridge is adapted to house a vibration producing assembly that imparts vibrations to the body. The fishing lure further includes an attractant delivery system and a noise making device. The vibration producing assembly is further sufficiently lightweight so as to enable the body and attached removable head to float at or near the surface of a surrounding body of water. The attractant delivery system dispenses fish attractant responsive to the vibrations imparted to the body by the vibration producing assembly. The noise making device produces sound responsive to the vibrations imparted to the body by the vibration producing assembly.

### CROSS-REFERENCE TO RELATED APPLICATION

This application is a continuation-in-part of application Ser. No. 09/535,880, which was filed Mar. 28, 2000.

### BACKGROUND OF THE INVENTION

1. Field of the Invention

The present invention relates to fishing lures and, more particularly, but not by way of limitation, to a fishing lure that is particularly designed to take advantage of each sense used by fish to hunt for food (i.e., vibration detection, hearing, smell, and sight) without sacrifice of one principle for another.

2. Description of the Related Art

Fish generally prefer live or freshly killed food. As a result, they have become adapted to utilize their senses of vibration detection, hearing, smell, and sight to focus their hunts toward live foodstuffs. Capitalizing on this knowledge, many sporting goods manufacturers have proposed fishing lure designs in which an element of the lure is adapted to provide a vibration, a sound, a smell or a look that simulates live food. For example, many if not most lures incorporate a vibration effect, wherein the lure wobbles, to resemble a vital organism, as it is pulled through the water. Similarly, other lures have been formed in shapes that resemble baitfish, crawfish, worms or other components of a normal fish diet. Likewise, manufacturers have incorporated sound and smell into their designs as means for initially attracting fishes' attention. Particularly, lures include steel shot or other rattles within for making noises as the lure is vibrated through the water, and/or aromatic liquid fish attractants are applied to the exterior of the lure or are injected into cavities within the lure just prior to deployment.

Unfortunately, one element of the lure design must often be traded for effective implementation of another. For example, most lures look nothing like ordinary fish foodstuff. This failure to fully capitalize on one of the fish's senses, however, is not due to its unimportance. Rather, it is generally because the shape of the lure is most often dictated by the fluid dynamics involved in making the lure vibrate as it is pulled through the water, which is necessary for simulating vitality as well as for operating any internal rattle. As a further frustration atop the sacrificed look, it turns out that the generation of motion in this manner also suffers the drawback of requiring the fish to act immediately. If the fish hesitates to strike, the lure will be pulled out of reach and, usually, out of mind. The foregoing also applies to the employment of fish attractant in that the lure ejects the fish attractant as it is pulled through the water, which results in the fish attractant attracting fish to a location already vacated by the lure.

As a result of this deficiency, lures have been developed to incorporate an internal vibration mechanism generally consisting of an electrically operated motor for driving an eccentrically weighted shaft. Operation of the motor causes the lure to wobble according to the eccentric weight on the motor's shaft, obviating the need to draw the lure through the water to achieve the jerking motion that might be expected of a small bait fish or the like. Unfortunately, the internal vibration mechanisms of previous designs were inefficient and bulky, which rapidly depleted battery power and, worse, resulted in extremely heavy lures unable to float. The lures thus sank to or at least very near the bottom, which rendered them largely ineffective in attracting fish.

With the deficiencies of the related art in mind, it is therefore a primary object of the present invention to improve over the related art by providing a fishing lure adapted to play to each sense used by hunting fish, without necessity for sacrifice of one principle for another. The fishing lure is therefore capable of producing vibration and sound and dispersing fish attractant without the necessity of pulling the lure through the water. Further, the fishing lure resembles common live foodstuffs fed upon by fish. Finally, it is another object of the present invention to provide a fishing lure that either floats or is capable of diving before returning to the surface.

### SUMMARY OF THE INVENTION

In accordance with the present invention, a fishing lure includes a body, a cartridge suitable for insertion into the body and adapted to house a vibration producing assembly, and a removable head securable to the body. The body includes a chamber for receiving the cartridge therein. The fishing lure further includes an attractant delivery system and a noise making device. The body, removable head, cartridge, and vibration producing assembly are sufficiently lightweight so as to enable the body and attached removable head to float at or near the surface of a surrounding body of water. The body and the removable head are shaped to resemble fish foodstuff. The removable head is configured to either facilitate diving or maintain a desired level as the fishing lure is pulled through surrounding water.

The vibration producing assembly imparts vibrations to the body and includes a battery and an electric motor. The cartridge includes a compartment that contains the electric motor and a chamber that receives the battery therein. The electric motor includes a shaft having an eccentric weight attached thereto, which is positioned on the shaft off the central axis of the fishing lure. The vibration producing assembly further includes a first terminal connected to the electric motor and disposed in the chamber for engagement with the battery and a return line terminating in a second terminal attached to the cartridge. The removable head includes a contact plate that engages the battery and the second terminal, thereby facilitating the delivery of power from the battery to the electric motor.

The attractant delivery system dispenses fish attractant responsive to the vibrations imparted to the body by the vibration producing assembly. The attractant delivery system includes a length of tubing positioned adjacent the body. The length of tubing includes an aperture for receiving fish attractant and an outlet therefrom for dispensing fish attractant responsive to the vibrations imparted to the body by the vibration producing assembly. The length of tubing attaches to the body to resemble a dorsal fin of a baitfish.

The noise making device, which is preferably a bell, produces sound responsive to the vibrations imparted to the body by the vibration producing assembly. The body includes a compartment housing the noise making device therein.

A method of catching fish includes inserting into a fishing lure a cartridge adapted to house a vibration producing assembly; activating the vibration producing assembly, thereby imparting vibrations to the fishing lure; and casting the fishing lure into a body of water. The method of catching fish further includes delivering fish attractant into the water from an attractant delivery system operated responsive to the vibrations imparted to the fishing lure. The method of catching fish still further includes producing sound using a noise making device disposed in the fishing lure and operated responsive to the vibrations imparted to the fishing lure.

Finally, many other features, objects and advantages of the present invention will be apparent to those of ordinary skill in the relevant arts, especially in light of the foregoing discussions and the following drawings, exemplary detailed description, and appended claims.

### BRIEF DESCRIPTION OF THE DRAWINGS

Although the scope of the present invention is much broader than any particular embodiment, a detailed description of the preferred embodiment follows together with illustrative figures, wherein like reference numerals refer to like components, and wherein:

FIG. 1 illustrates, in a perspective view, a first preferred embodiment of the fishing lure of the present invention;

FIG. 2 illustrates, in a cut away side view, the fishing lure of FIG. 1;

FIG. 3 illustrates, in a cut away side view, a cartridge of the fishing lure of FIG. 1;

FIG. 4 illustrates, in a cut away side view, a removable head of the fishing lure of FIG. 1; and

FIG. 5 illustrates, in a side view, a second preferred embodiment of the fishing lure of the present invention.

### DETAILED DESCRIPTION OF THE PREFERRED EMBODIMENTS

Although those of ordinary skill in the art will readily recognize many alternative embodiments, especially in light of the illustrations provided herein, this detailed description is exemplary of the preferred embodiment of the present invention, the scope of which is limited only by the claims appended hereto.

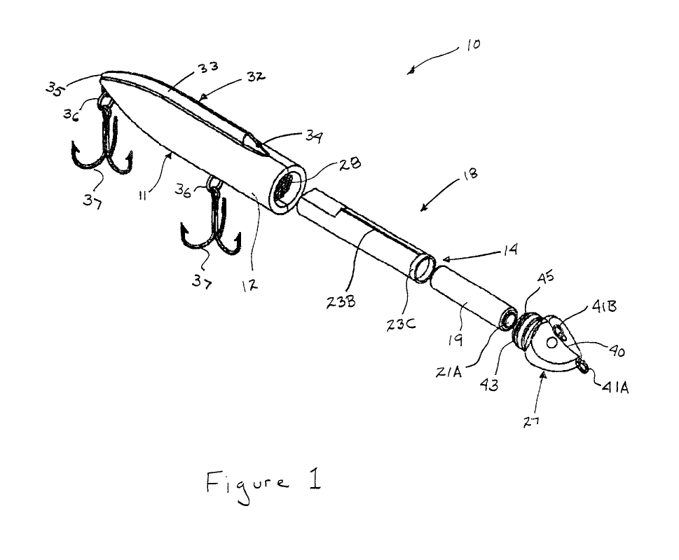

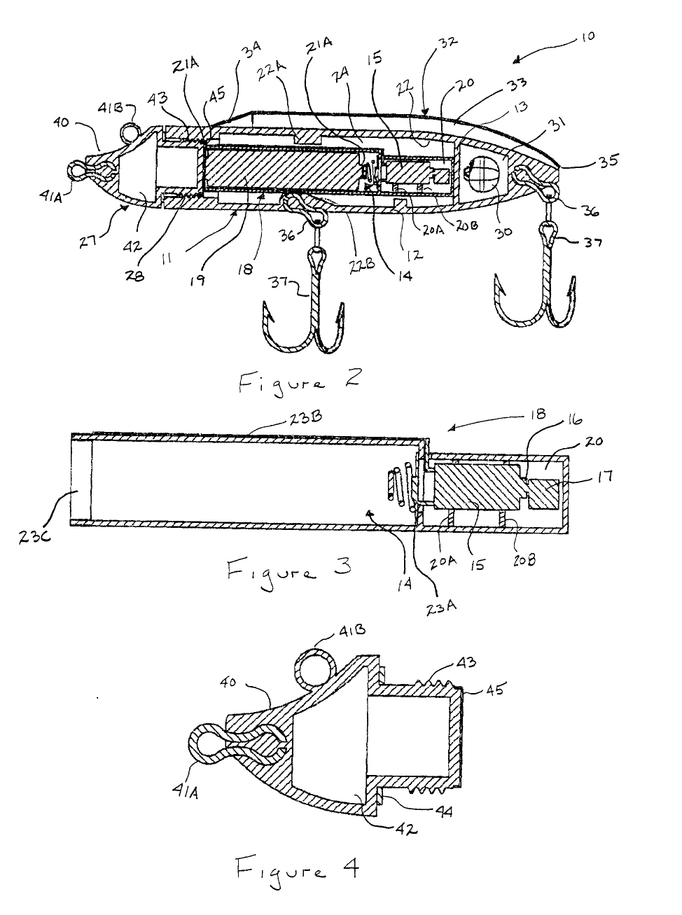

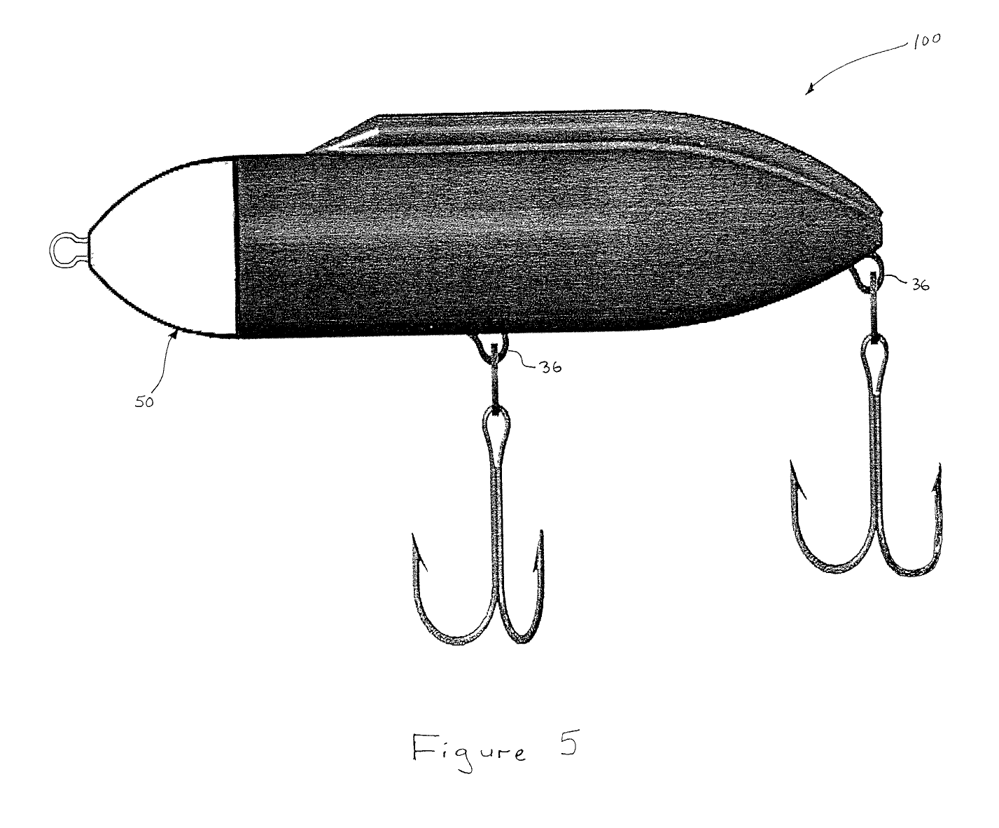

Referring now to FIGS. 1-4, the lure 10 of this first preferred embodiment is shown to generally comprise a body 11 with a removable head 27. The body 11 generally comprises a hull 12, which includes a bulkhead 13 and a chamber wall 22. The hull 12 of the body 11 preferably comprises two halves that are secured together to form the hull 12 using any suitable means, such as friction or an adhesive. However, those of ordinary skill in the art will recognize many techniques to form the hull 12. The body 11, in this first embodiment, is shaped to resemble a small bait-type fish. Nevertheless, those of ordinary skill in the art will readily recognize that the body 11 may comprise any shape and particularly any shape similar to fish foodstuff, such as frogs, grasshoppers and certain other insects, worms, and the like. Consequently, the lure 10 resembles typical fish foodstuff to capitalize on fishes' sense of sight. As will be better understood further herein, the lure 10 resembles typical fish foodstuff without sacrificing the other fish attraction aspects of vibration detection, hearing, and smell.

As shown particularly in FIGS. 2 and 3, the bulkhead 13 and the chamber wall 22 define a chamber 24 that removably receives a cartridge 18 therein. The chamber wall 22 includes protrusions 22A and 22B that frictionally engage the cartridge 18 to aid in preventing movement of the cartridge 18 about the chamber 24. The cartridge 18 provides a housing for a vibration producing assembly 14, which generally comprises an electric motor 15 and a battery 19. The cartridge 18 defines a compartment 20 that receives the motor 15 therein. The compartment includes bulkheads 20A and B that secure the motor 15 within the cartridge 18. Likewise, the cartridge 18 defines a chamber 25 that receives the battery 19, which is secured therein by the removable head 27. The vibration producing assembly 14 further comprises a terminal 23A connected to the motor 15, which serves as the positive input, and a return line 23B connected to the motor 15 and terminating in terminal 23C. As will be better understood further herein, the vibration producing assembly 14 is particularly adapted to take advantage of a fish's sense of vibration detection.

The electric motor 15 comprises a shaft 16 having an eccentric weight 17 attached thereto. The eccentric weight 17 preferably attaches to the shaft 16 off the central axis of the lure 10. Thus, as the motor 15 rotates the eccentric weight 17 via the shaft 16, the eccentric weight 17 causes the lure 10 to wobble or vibrate, thereby resulting in the lure 10 imparting vibrations into the surrounding water that are detectable by fish. Consequently, the lure 10 capitalizes on fishes' sense of vibration detection in an improved manner in that the lure 10 produces detectable vibrations without the necessity of the lure 10 being pulled through the water, thereby drawing fish to the exact location of the lure.

As shown particularly in FIGS. 1-4, the removable head 27 in this first preferred embodiment defines a cavity 42 and includes a curved surface 40. The curved surface 40 of the removable head 27 permits the lure 10 to perform dives when it is desirable to pull the lure 10 through the water before returning to a normal floating level. Particularly, water flowing over the curved surface 40 drives the lure 10 downward followed by the lure 10 returning to a normal floating level, thereby providing the lure 10 with motion that simulates certain live fish foodstuff. The removable head 27, in this first embodiment, is shaped to resemble a head of a small bait-type fish. Nevertheless, those of ordinary skill in the art will readily recognize that the removable head 27 may comprise any head shaped similar to fish foodstuff, such as frogs, grasshoppers and certain other insects, worms, and the like.

The removable head 27 further includes threads 43 that engage threads 28 of the hull 12 to permit removable attachment of the removable head 27 to the body 11 as well as an O-ring 44 that prevents water leakage into the chamber 25. Eye-hooks 41A and B attach to the nose and the upper portion of the removable head 27, respectively, using any suitable means, such as integral formation therewith during a molding process, to allow securing of the lure 10 to a fishing line.

The removable head 27 still further includes a contact plate 45 attached at its rear using any suitable means, such as integral formation therewith during a molding process for the removable head 27. The contact plate 45 forms a terminal for the vibration producing assembly 14. The contact plate 45 further maintains the battery 19 engaged with the terminal 23A when the removable head 27 is completely engaged with the body 11. As such, the positive terminal 21A of the battery 19 engages the terminal 23A, and the contact plate 45 engages the negative terminal 21B. In addition, the contact plate 45 engages the terminal 23C of the return line 23B. Accordingly, a complete circuit is formed that allows the battery 19 to provide power to the electric motor 15. As long as the removable head 27 is secured to the body 11, the electric motor 15 operates to impart vibrations into the surrounding water that are detectable by fish. Although this first embodiment discloses a removable head 27, those of ordinary skill in the art will readily recognize that the lure 10 may include a removable tail section that operates in place of the removable head 27.

The inclusion of the cartridge 18 in the lure 10 provides the advantage of allowing replacement of the motor 15. Damage to a fishing lure motor ruins the lure and results in the necessity of a costly replacement of the entire lure. However, in the event of damage to the motor 15, the cartridge 18 is removed and replaced with a new one, thus allowing continued use of the body 11 and the removable head 27. Furthermore, a single cartridge 18 may service multiple lures, thus eliminating the necessity of purchasing multiple more expensive lures.

As also shown in FIG. 2, the body 11 includes a compartment 31 having a noise making device therein, which according to this first preferred embodiment, is a bell 30. Those of ordinary skill in the art, however, will recognize many substantially equivalent embodiments for the noise making device. It should be noted, however, that the bell embodiment shown in FIG. 2 is preferred for its light weight and propensity to make noise as a consequence of the vibrations imparted to the lure 10 through the rotation of the eccentric weight 17. Consequently, the lure 10 capitalizes on fishes' sense of hearing in an improved manner in that the lure 10 produces detectable sounds without the necessity of the lure 10 being pulled through the water, thereby drawing fish to the exact location of the lure 10.

Finally, as particularly shown in FIGS. 1 and 2, the lure 10 of this first embodiment also comprises a unique attractant delivery system 32. The attractant delivery system 32 generally comprises a length of tubing 33 attached to the body 11 and configured to resemble the dorsal fin of a small bait-type fish. Nevertheless, those of ordinary skill in the art will readily recognize that the tubing 33 may comprise any shape and particularly any shape related to a body part of fish foodstuff, such as frogs, grasshoppers and certain other insects, worms, and the like. The tubing 33 is attached to the body 11 using any suitable means, such as integral formation therewith during a molding process for the body 11.

The tubing 33 includes an aperture 34 positioned towards its front and an outlet 35 therefrom positioned at the rear of the tubing 33. Fish attractant is delivered into the tubing 33 at the aperture 34 using a bottle including a tube sized to fit within the aperture 34. The fish attractant remains within the tubing 33 and does not readily exit the outlet 35 due to capillary action within the tubing 33. However, upon engagement of the motor 15 and the rotation of the eccentric weight 17, the vibrations imparted to the lure 10 overcome the capillary action within the tubing 33, thereby facilitating a controlled release of the fish attractant into the surrounding water. Consequently, the lure 10 capitalizes on fishes' sense of smell in an improved manner in that the lure 10 releases fish attractant without the necessity of the lure 10 being pulled through the water, thereby drawing fish to the exact location of the lure 10. Although not critical for successful use of the lure 10, it has been found that the use of a red colored attractant contributes to the success of the lure 10 by giving the appearance of wounded fish foodstuff.

As particularly shown in FIG. 5, a lure 100 of the second preferred embodiment is identical to and includes each feature of the lure 10 of the first preferred embodiment, except a removable head 50 has been substituted for the removable head 27. The removable head 50 is identical to and includes each feature of the removable head 27, except the curved surface 40 of the removable head 27 has been eliminated. As such, the removable head 50 does not facilitate diving of the lure 100 when it is desirable to pull the lure 10 through the water. Water flows evenly around the removable head 50, resulting in the lure 100 traveling straight at a desired floating level, thereby providing the lure 100 with motion that simulates certain live fish foodstuff. The removable head 50, in this second embodiment, is shaped to resemble a head of a small bait-type fish. Nevertheless, those of ordinary skill in the art will readily recognize that the removable head 50 may comprise any head shaped similar to fish foodstuff, such as frogs, grasshoppers and certain other insects, worms, and the like. Although this second embodiment discloses a removable head 50, those of ordinary skill in the art will readily recognize that the lure 10 may include a removable tail section that operates in place of the removable head 27.

The weight of lures 10 and 100 is of extreme importance in their designs. Particularly, the lures 10 and 100 must float at or very near the surface of surrounding water to be effective in attracting fish. Consequently, the lures 10 and 100 are constructed from light weight materials, and, more importantly, the motor 15 must be sufficiently small and light weight that it allows the lures 10 and 100 to float at or very near the surface of surrounding water. Furthermore, the motor 15 must draw minimal current from the battery 19, which conserves the charge on the battery 19 and prevents the battery 19 from adding weight to lures 10 and 100 that would prevent the lures 10 and 100 from floating at or very near the surface of surrounding water.

It should be understood that the weight of the lures 10 and 100 may be adjusted by manipulating the weight of the removable heads 27 and 50 through filling of their respective cavities with additional material. As such, the lure 10 may be constructed to float at the surface of the surrounding water, just below the surface of the surrounding water, or even deeper depending upon the type of fish desired for attraction. Furthermore, as previously described, the removable head 27 is designed to permit diving of the lure 10 when it is desirable to pull the lure 10 through the surrounding water before returning to float at or very near the surface of the surrounding water. Alternatively, the removable head 50 is designed to maintain lure 10 floating at or very near the surface of the surrounding water when it is desirable to pull the lure 10 through the surrounding water.

While the foregoing description is exemplary of the preferred embodiment of the present invention, those of ordinary skill in the relevant arts will recognize the many variations, alterations, modifications, substitutions and the like as are readily possible, especially in light of this description, the accompanying drawings and claims drawn thereto. For example, various eyehooks 36 and treble hooks 37 may be provided according to the size and type of fish to be attracted by the lure 10. In any case, because the scope of the present invention is much broader than any particular embodiment, the foregoing detailed description should not be construed as a limitation of the scope of the present invention, which is limited only by the claims appended hereto.

What is claimed is:

1. A fishing lure, comprising:
a body;
a cartridge insertable into the body, the cartridge being adapted to house a vibration producing assembly that imparts vibrations to the body; and
a removable head securable to the body.

2. The fishing lure according to claim 1, wherein the vibration producing assembly comprises a battery and an electric motor.

3. The fishing lure according to claim 2, wherein the cartridge defines a compartment that receives the electric motor therein.

4. The fishing lure according to claim 3, wherein the compartment includes a bulkhead that secures the electric motor within the cartridge.

5. The fishing lure according to claim 3, wherein the cartridge defines a chamber that receives the battery therein.

6. The fishing lure according to claim 2, wherein the electric motor includes a shaft having an eccentric weight attached thereto.

7. The fishing lure according to claim 6, wherein the eccentric weight is positioned on the shaft off the central axis of the fishing lure.

8. The fishing lure according to claim 5, wherein the vibration producing assembly further comprises:
a first terminal connected to the electric motor and disposed in the chamber for engagement with the battery; and
a return line terminating in a second terminal, the return line and second terminal being attached to the cartridge.

9. The fishing lure according to claim 8, wherein the removable head includes a contact plate that engages the battery and the second terminal, thereby facilitating the delivery of power from the battery to the electric motor.

10. The fishing lure according to claim 1, wherein the body includes a chamber for receiving the cartridge therein.

11. The fishing lure according to claim 10, wherein the chamber includes protrusions that aid in preventing movement of the cartridge about the chamber.

12. The fishing lure according to claim 1, wherein the body and the removable head are shaped to resemble fish foodstuff.

13. The fishing lure according to claim 1, further comprising an attractant delivery system, wherein the attractant delivery system dispenses fish attractant responsive to the vibrations imparted to the body by the vibration producing assembly.

14. The fishing lure according to claim 13, wherein the attractant delivery system comprises a length of tubing positioned adjacent the body.

15. The fishing lure according to claim 14, wherein the length of tubing includes an aperture for receiving fish attractant and an outlet therefrom for dispensing fish attractant responsive to the vibrations imparted to the body by the vibration producing assembly.

16. The fishing lure according to claim 14, wherein the length of tubing attaches to the body to resemble a dorsal fin of a bait fish.

17. The fishing lure according to claim 1, wherein the removable head is configured to facilitate diving as the fishing lure is pulled through surrounding water.

18. The fishing lure according to claim 1, wherein the removable head is configured to maintain a desired level as the fishing lure is pulled through surrounding water.

19. The fishing lure according to claim 1 further comprising a noise making device disposed in the body, wherein the noise making device produces sound responsive to the vibrations imparted to the body by the vibration producing assembly.

20. The fishing lure according to claim 19, wherein the noise making device comprises a bell.

21. The fishing lure according to claim 19, wherein the body includes a compartment that houses the noise making device therein.

22. A method of catching fish, comprising:
inserting into a fishing lure a cartridge adapted to house a vibration producing assembly;
activating the vibration producing assembly, thereby imparting vibrations to the fishing lure; and
casting the fishing lure into a body of water.

23. The method according to claim 22 further comprising delivering fish attractant into the water from an attractant delivery system operated responsive to the vibrations imparted to the fishing lure.

24. The method of catching fish according to claim 22, further comprising producing sound using a noise making device disposed in the fishing lure and operated responsive to the vibrations imparted to the fishing lure.

25. A method of catching fish, comprising:
inserting into a body of a fishing lure a cartridge adapted to house a vibration producing assembly;
inserting into the cartridge a battery of the vibration producing assembly;
securing a removable head of the fishing lure to the body, thereby activating the vibration producing assembly and imparting vibrations to the fishing lure; and
casting the fishing lure into a body of water.

26. The method according to claim 25 further comprising delivering fish attractant into the water from an attractant delivery system operated responsive to the vibrations imparted to the fishing lure.

27. The method of catching fish according to claim 25, further comprising producing sound using a noise making device disposed in the fishing lure and operated responsive to the vibrations imparted to the fishing lure.
